(19) United States
(12) Patent Application Publication
(10) Pub. No.: US 2023/0217551 A1
(43) Pub. Date: Jul. 6, 2023

(54) HEATING DEVICE AND DETECTING METHOD THEREOF

(71) Applicant: Delta Electronics, Inc., Taoyuan City (TW)

(72) Inventors: Ming-Shi Huang, Taoyuan City (TW); Zheng-Feng Li, Taoyuan City (TW); Jhih-Cheng Hu, Taoyuan City (TW); Yi-Liang Lin, Taoyuan City (TW); Yu-Min Meng, Taoyuan City (TW); Chun-Wei Lin, Taoyuan City (TW); Chun Chang, Taoyuan City (TW); Thiam Wee Tan, Taoyuan City (TW)

(21) Appl. No.: 17/689,830

(22) Filed: Mar. 8, 2022

(30) Foreign Application Priority Data
Dec. 30, 2021 (CN) 202111667832.5

(51) Int. Cl. H05B 6/06; H02M 7/537; H05B 6/12

(52) U.S. Cl. CPC H05B 6/062; H02M 7/537; H05B 6/1209; H05B 2213/05

(57) ABSTRACT

A heating device includes a resonant circuit, a detection unit and a control unit. The resonant circuit includes an inverter circuit and a resonant tank. The inverter circuit provides a resonant tank current and a resonant tank voltage. The resonant tank includes a heating coil, a resonant tank capacitor, a resonant tank equivalent inductor and a resonant tank equivalent impedance. The detection unit detects the resonant tank current and the resonant tank voltage to acquire associated parameters. The detection unit calculates an inductance of the resonant tank equivalent inductor according to a capacitance of the resonant tank capacitor, a resonant period and a first expression. The detection unit calculates an impedance value of the resonant tank equivalent impedance according to the inductance of the resonant tank equivalent inductor, a time difference, the resonant period, a reference current value, a negative peak current value and a second expression.

### CROSS-REFERENCE TO RELATED APPLICATION

This application claims the priority to Chinese Patent Application No. 202111667832.5 filed on Dec. 30, 2021, the entire contents of which are incorporated herein by reference for all purposes.

### FIELD OF THE INVENTION

The present invention relates to a heating device, and more particularly to a heating device with a resonant tank and a detecting method thereof. By utilizing the natural response characteristics of the resonant tank in the negative half cycle, the inductance of the resonant tank equivalent inductor and the impedance value of the resonant tank equivalent impedance are calculated according to the current and voltage information of the resonant tank.

### BACKGROUND OF THE INVENTION

In recent years, with the advancement of science and technology, the heating device for people to cook is no longer only a single choice. In addition to the heating device heated by gas fuel, there are also a variety of options such as microwave ovens, infrared ovens and electric heating stove driven by electricity. Different heating devices have their advantages or disadvantages. These various heating devices can be applied to various cooking and cooking occasions of different ingredients to meet the needs of users with different requirements.

Take an induction cooking stove as an example of the heating device. When a current flows through the induction coil (or a heating coil) of the induction cooking stove, electromagnetic induction is performed to produce eddy current, thereby heating a foodstuff container. By adjusting electricity to the induction coil, the heat quantity for heating the foodstuff container is determined. Depending on the location of the foodstuff container relative to the induction coil and the material of the foodstuff container, the heat quantity for heating the foodstuff container by the induction coil and the operating condition and the current magnitude of the induction coil are varied. Generally, in case that the locations of the foodstuff containers or the materials of the foodstuff containers are different, different equivalent parameters are sensed by a resonant tank of the conventional induction cooking stove. In accordance with a conventional technology, the resonant tank equivalent impedance value and the resonant tank equivalent inductance are calculated according to the resonant tank voltage, the resonant tank current and the phase difference between the resonant tank voltage and the resonant tank current. According to the calculation results of the resonant tank equivalent impedance value and the resonant tank equivalent inductance, the electric power of the induction coil is adjusted. However, the conventional technology still has some drawbacks. For example, the conventional heating device needs to be additionally equipped with a voltage detection circuit and a current detection circuit. Consequently, the circuitry structure of the conventional heating device is complicated, and the fabricating cost is high.

Therefore, there is a need of providing an improved heating device and a suitable detecting method in order to overcome the drawbacks of the conventional technologies.

### SUMMARY OF THE INVENTION

The present invention provides a heating device and a detecting method for the heating device. The heating device includes a resonant tank. By utilizing the natural response characteristics of the resonant tank in the negative half cycle, the inductance of the resonant tank equivalent inductor and the impedance value of the resonant tank equivalent impedance are calculated according to the current and voltage information of the resonant tank. When compared with the conventional heating device, the heating device of the present invention does not need to equip with too many detection circuits. Consequently, the heating device is simplified and the cost is reduced.

In accordance with an aspect of present invention, a heating device is provided. The heating device includes a resonant circuit, a detection unit and a control unit. The resonant circuit includes an inverter circuit and a resonant tank. The inverter circuit provides a resonant tank current and a resonant tank voltage. The resonant tank includes a heating coil, a resonant tank capacitor, a resonant tank equivalent inductor and a resonant tank equivalent impedance. The detection unit is electrically coupled with the resonant circuit. The detection unit detects the resonant tank current and the resonant tank voltage to acquire a reference current value, a first zero-crossing time point, a second zero-crossing time point, a time difference, a resonant period and a negative peak current value. The reference current value is a current value of the resonant tank current when the resonant tank voltage is zero. The time difference is a time length between a time point when the resonant tank voltage is zero and the first zero-crossing time point. The resonant period is defined according to the first zero-crossing time point and the second zero-crossing time point. The control unit controls the inverter circuit to output the resonant tank current and the resonant tank voltage. Consequently, a heating power of the heating coil is adjustable. The detection unit calculates an inductance of the resonant tank equivalent inductor according to a capacitance of the resonant tank capacitor, the resonant period and a first expression. The detection unit calculates an impedance value of the resonant tank equivalent impedance according to the inductance of the resonant tank equivalent inductor, the time difference, the resonant period, the reference current value, the negative peak current value and a second expression. The control unit controls the heating power of the heating coil according to the inductance of the resonant tank equivalent inductor and the impedance value of the resonant tank equivalent impedance. The first expression is expressed as a following mathematic formula:

$${L}_{eq} = {( \frac{1}{2 π T \sqrt{{C}_{r}}} )}^{2} ,$$

where L_{eq} is the inductance of the resonant tank equivalent inductor, Cᵣ is the capacitance of the resonant tank capacitor, and T is the resonant period, and the second expression is expressed as a following mathematic formula:

$${R}_{eq} = \frac{2 {L}_{eq}}{Δ t + \frac{T}{4}} ln ( \frac{- {I}_{0}}{{I}_{N}} \frac{1}{sin ( \frac{Δ t}{T} 2 π )} ) .$$

where R_{eq} is the impedance value of the resonant tank equivalent impedance, I₀ is the reference current value, Δt is the time difference, and I_{N} is the negative peak value of the resonant tank current.

In accordance with another aspect of present invention, a detecting method for a detection unit of a heating device is provided. The heating device further includes a resonant circuit. The resonant circuit includes an inverter circuit and a resonant tank. The inverter circuit provides a resonant tank current and a resonant tank voltage. The resonant tank includes a heating coil, a resonant tank capacitor, a resonant tank equivalent inductor and a resonant tank equivalent impedance. The detecting method includes the following steps:

(a) detecting the resonant tank current and the resonant tank voltage to acquire a reference current value, a first zero-crossing time point, a second zero-crossing time point, a time difference, a resonant period and a negative peak current value, wherein the reference current value is a current value of the resonant tank current when the resonant tank voltage is zero, the time difference is a time length between a time point when the resonant tank voltage is zero and the first zero-crossing time point, and the resonant period is defined according to the first zero-crossing time point and the second zero-crossing time point;

(b) calculating an inductance of the resonant tank equivalent inductor according to a capacitance of the resonant tank capacitor, the resonant period and a first expression, wherein the first expression is expressed as a following mathematic formula:

$${L}_{eq} = {( \frac{1}{2 π T \sqrt{{C}_{r}}} )}^{2} ,$$

where L_{eq} is the inductance of the resonant tank equivalent inductor, Cᵣ is the capacitance of the resonant tank capacitor, and T is the resonant period;

(c) calculating an impedance value of the resonant tank equivalent impedance according to the inductance of the resonant tank equivalent inductor, the time difference, the resonant period, the reference current value, the negative peak current value and a second expression, wherein the second expression is expressed as a following mathematic formula:

$${R}_{eq} = \frac{2 {L}_{eq}}{Δ t + \frac{T}{4}} ln ( \frac{- {I}_{0}}{{I}_{N}} \frac{1}{sin ( \frac{Δ t}{T} 2 π )} ) ,$$

where R_{eq} is the impedance value of the resonant tank equivalent impedance, I₀ is the reference current value, Δt is the time difference, and I_{N} is the negative peak value of the resonant tank current; and

(d) controlling a heating power of the heating coil according to the inductance of the resonant tank equivalent inductor and the impedance value of the resonant tank equivalent impedance.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic functional block diagram illustrating the architecture of a heating device according to an embodiment of the present invention;

FIG. 1B is schematic circuit diagram illustrating the heating device as shown in FIG. 1A;

FIG. 2 is a schematic timing waveform diagram illustrating the control voltage for controlling the upper switch and the resonant tank current in the heating device of FIG. 1B;

FIG. 3 is a schematic circuit diagram illustrating the zero-crossing detection circuit in the parameter acquisition unit of the detection unit as shown in FIG. 1B;

FIG. 4 is a schematic timing waveform diagram illustrating the control voltage for controlling the upper switch, the resonant tank current and the PWM signal from the zero-crossing detection circuit;

FIG. 5 is a schematic circuit diagram illustrating the negative peak value detection circuit in the parameter acquisition unit of the detection unit as shown in FIG. 1B; and

FIG. 6 is a flowchart illustrating a detecting method for a heating device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

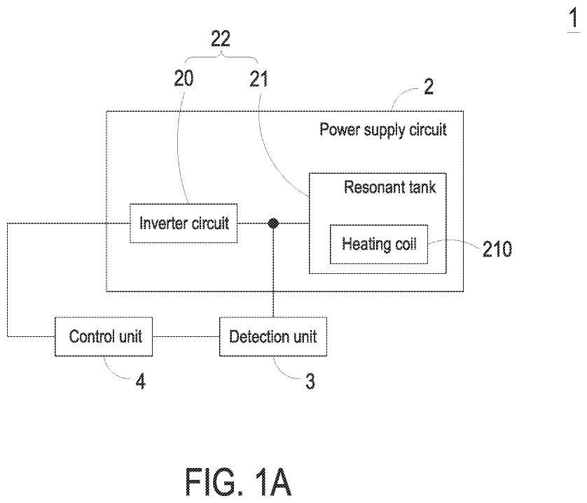

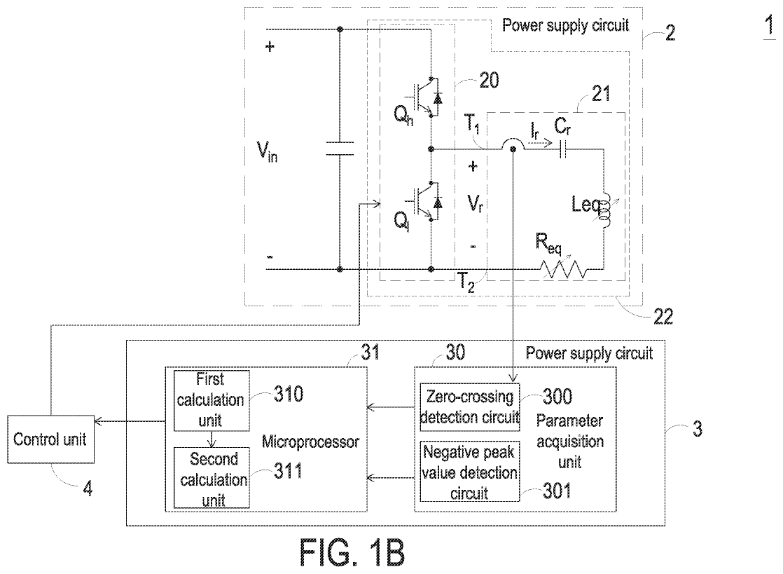

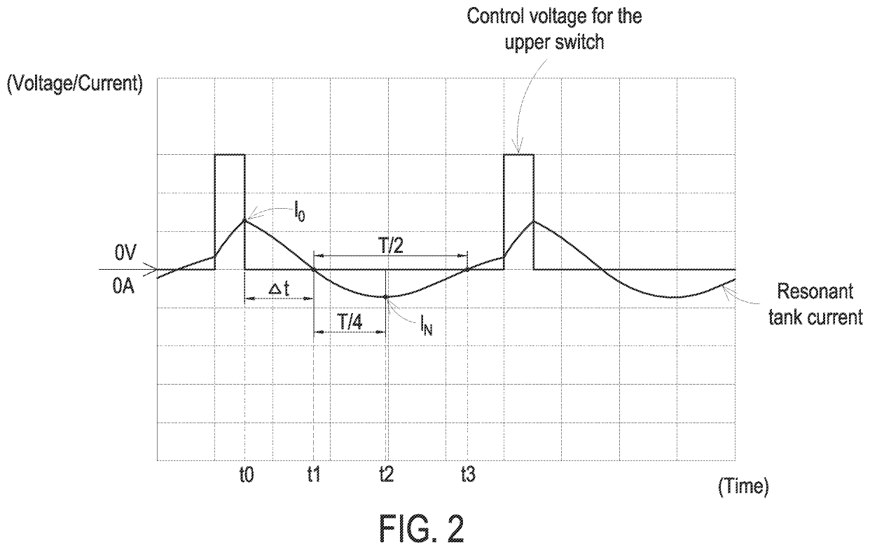

Please refer to FIGS. 1A, 1B and 2. FIG. 1A is a schematic functional block diagram illustrating the architecture of a heating device according to an embodiment of the present invention. FIG. 1B is schematic circuit diagram illustrating the heating device as shown in FIG. 1A. FIG. 2 is a schematic timing waveform diagram illustrating the control voltage for controlling the upper switch and the resonant tank current in the heating device of FIG. 1B. Preferably but not exclusively, the heating device 1 is an induction cooking stove. The heating device 1 includes a power supply circuit 2, a detection unit 3 and a control unit 4.

The power supply circuit 2 includes a resonant circuit 22. The resonant circuit 22 includes an inverter circuit 20 and a resonant tank 21. The inverter circuit 20 receives an input voltage Vᵢₙ. The inverter circuit 20 includes at least one switch. For example, as shown in FIG. 1B, the inverter circuit 20 includes an upper switch Qₕ and a lower switch Qₗ. The upper switch Qₕ and the lower switch Qₗ are connected with each other in series. Consequently, the inverter circuit 20 is formed as a half-bridge inverter circuit. By alternately turning on and turning off the upper switch Qₕ and the lower switch Qₗ, the input voltage Vᵢₙ is converted by the inverter circuit 20. Consequently, a resonant tank current Iᵣ and a resonant tank voltage Vᵣ are outputted from the inverter circuit 20. Moreover, each of the upper switch Qₕ and the lower switch Qₗ includes a control terminal, a first conducting terminal and a second conducting terminal.

The resonant tank 21 includes a first terminal T₁, a second terminal T₂, a heating coil 210, a resonant tank capacitor Cᵣ, a resonant tank equivalent inductor L_{eq} and a resonant tank equivalent impedance R_{eq}. The first terminal T₁ and the second terminal T₂ of the resonant tank 21 are electrically coupled with the two conducting terminals of one of the two switches of the inverter circuit 20. As shown in FIG. 1B, the first terminal T₁ of the resonant tank 21 is electrically coupled with the first conducting terminal of the lower switch Qₗ, and the second terminal T₂ of the resonant tank 21 is electrically coupled with the second conducting terminal of the lower switch Qₗ. The resonant tank capacitor Cᵣ, the resonant tank equivalent inductor Le and the resonant tank equivalent impedance R_{N} are serially connected between the first terminal T₁ and the second terminal T₂ in sequence. It is noted that the connection sequence of the resonant tank capacitor Cᵣ, the resonant tank equivalent inductor L_{eq} and the resonant tank equivalent impedance R_{eq} between the first terminal T₁ and the second terminal T₂ is not restricted and is varied according to the practical requirements. The foodstuff container (not shown) on the heating device 1 is heated by heating coil 210 through induction according to the resonant tank current Iᵣ and the resonant tank voltage Vᵣ from the inverter current 20. Moreover, the resonant tank 21, the heating coil 210 and the foodstuff container are collaboratively equivalent to the resonant tank equivalent inductor Le, and the resonant tank 21, the heating coil 210 and the foodstuff container are also equivalent to the resonant tank equivalent impedance R_{eq}. In addition, the capacitance of the resonant tank capacitor C is a known value.

As mentioned above, the inductance of the resonant tank equivalent inductor L_{eq} is related with the inductance of the heating coil 210, the material of the foodstuff container and the location of the foodstuff container on the heating device 1. In other words, when any one of the inductance of the heating coil 210, the material of the foodstuff container and the location of the foodstuff container on the heating device 1 is changed, the inductance of the resonant tank equivalent inductor L_{eq} is correspondingly changed. Similarly, the impedance value of the resonant tank equivalent impedance R_{eq} is related with the impedance value of the heating coil 210, the material of the foodstuff container and the location of the foodstuff container on the heating device 1. In other words, when any one of the impedance value of the heating coil 210, the material of the foodstuff container and the location of the foodstuff on the heating device 1 is changed, the impedance value of the resonant tank equivalent impedance R_{eq} is changed.

The control unit 4 is electrically coupled with the inverter circuit 20. The control unit 4 controls the inverter circuit 20 to output the resonant tank current Iᵣ and the resonant tank voltage Vᵣ to the resonant tank 21. Consequently, the heating power of the heating coil 210 is controlled.

The detection unit 3 is electrically coupled with the resonant circuit 22. For example, the detection unit 3 is electrically coupled between the first terminal T₁ of the resonant tank 21 and the resonant tank capacitor Cᵣ. Moreover, the detection unit 3 detects the resonant tank current Iᵣ and the resonant tank voltage Vᵣ to acquire the information about a reference current value I₀, a time difference Δt, a first zero-crossing time point, a second zero-crossing time point, a resonant period T and a negative peak current value I_{N}. The reference current value I₀ is a current value of the resonant tank current Iᵣ when the resonant tank voltage Vᵣ is zero. For example, when the upper switch Qₕ of the inverter circuit 20 is operated in the negative half cycle and switched from the conducting state to the non-conducting state and the resonant tank voltage Vᵣ is zero (e.g., at the time point t0), the instantaneous current value of the resonant tank current Iᵣ is served as the reference current value I₀. The first zero-crossing time point is the time point corresponding to the first zero value of the resonant tank current Iᵣ after the resonant tank voltage Vᵣ is zero (e.g., at the time point t1). The second zero-crossing time point is the time point corresponding to the second zero value of the resonant tank current Iᵣ after the resonant tank voltage Vᵣ is zero (e.g., at the time point t3). The time difference Δt is a time length between the time point t0 (i.e., the time point when the resonant tank voltage Vᵣ is zero) and the time point t1 (i.e., the first zero-crossing time point). The resonant period T is defined by the first zero-crossing time point and the second zero-crossing time point. The negative peak current value I_{N} is the maximum value of the resonant tank current Iᵣ when the resonant tank current Iᵣ is negative (i.e., at the time point t2).

In an embodiment, the detection unit 3 calculates the inductance of the resonant tank equivalent inductor L_{eq} according to the capacitance of the resonant tank capacitor Cᵣ, a first expression and the resonant period T. The first expression is expressed as the following mathematic formula (1):

$${L}_{eq} = {( \frac{1}{2 π T \sqrt{{C}_{r}}} )}^{2} ; \qquad ( 1 )$$

In the above mathematic formula, L_{eq} is the inductance of the resonant tank equivalent inductor, Cᵣ is the capacitance of the resonant tank capacitor, and T is the resonant period.

Moreover, the detection unit 3 calculates the impedance value of the resonant tank equivalent impedance R_{eq} according to the inductance of the resonant tank equivalent inductor Le, the time difference Δt, the resonant period T, the reference current value I₀, the negative peak value I_{N} of the resonant tank current Iᵣ and a second expression. The second expression is expressed as the following mathematic formula (2):

$${R}_{eq} = \frac{2 {L}_{eq}}{Δ t + \frac{T}{4}} ln ( \frac{- {I}_{0}}{{I}_{N}} \frac{1}{sin ( \frac{Δ t}{T} 2 π )} ) ; \qquad ( 2 )$$

In the above mathematic formula, R_{eq} is the impedance value of the resonant tank equivalent impedance, I₀ is the reference current value, Δt is the time difference, and I_{N} is the negative peak value of the resonant tank current.

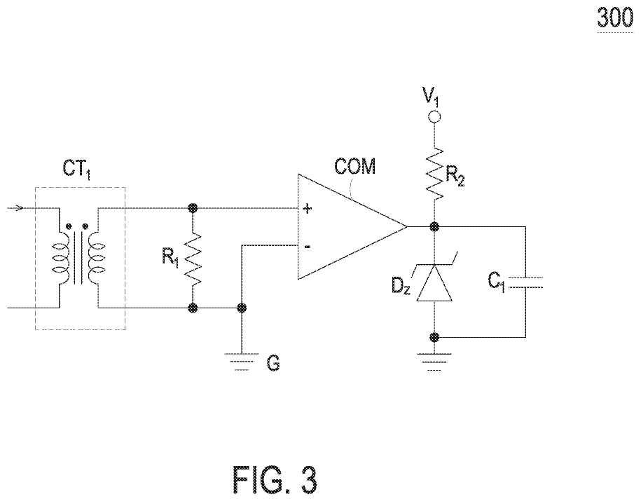

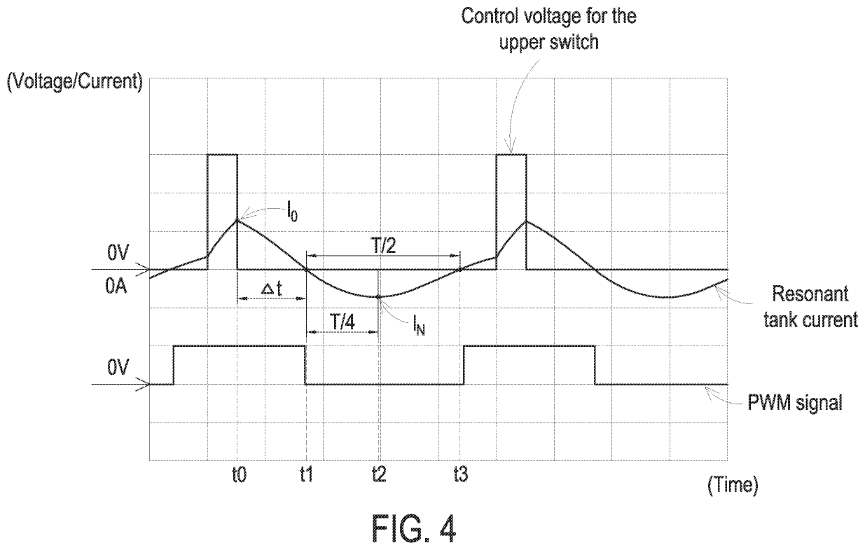

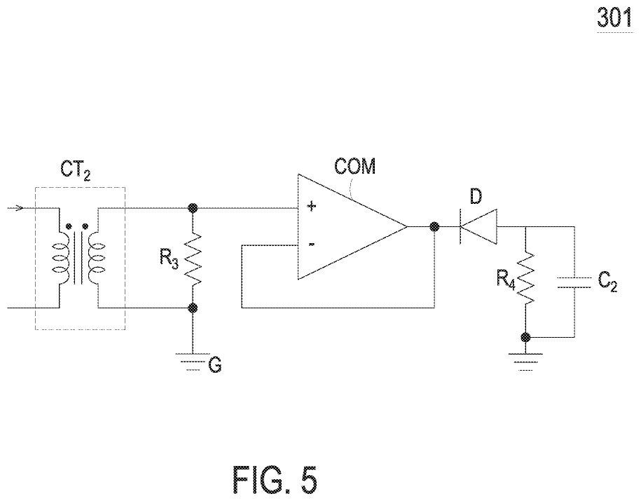

FIG. 3 is a schematic circuit diagram illustrating the zero-crossing detection circuit in the parameter acquisition unit of the detection unit as shown in FIG. 1B. FIG. 4 is a schematic timing waveform diagram illustrating the control voltage for controlling the upper switch, the resonant tank current and the PWM signal from the zero-crossing detection circuit. FIG. 5 is a schematic circuit diagram illustrating the negative peak value detection circuit in the parameter acquisition unit of the detection unit as shown in FIG. 1B.

Please refer to FIGS. 1B, 3, 4, 5. The detection unit 3 includes a parameter acquisition unit 30 and a microprocessor 31. The parameter acquisition unit 30 is electrically coupled with the resonant circuit 22. For example, the parameter acquisition unit 30 is electrically coupled with the first terminal T₁ of the resonant tank 21 and the resonant tank capacitor Cᵣ. The parameter acquisition unit 30 detects the resonant tank current Iᵣ and the resonant tank voltage Vᵣ. When the inverter circuit 20 is operated in the negative half cycle and the resonant tank voltage Vᵣ is zero (e.g., when the upper switch Qₕ of the inverter circuit 20 is operated in the negative half cycle and switched from the conducting state to the non-conducting state), the parameter acquisition unit 30 acquires the information about the resonant period T of the resonant tank 21 and the negative peak current value I_{N} of the resonant tank current Iᵣ according to the resonant tank current Iᵣ and the resonant tank voltage Vᵣ.

The parameter acquisition unit 30 can be implemented with a hardware component or a software component. In the embodiment of FIG. 1B, the parameter acquisition unit 30 is implemented with the hardware component. In addition, the parameter acquisition unit 30 includes a zero-crossing detection circuit 300 and a negative peak value detection circuit 301.

The zero-crossing detection circuit 300 is electrically coupled with the resonant tank 21. For example, the zero-crossing detection circuit 300 is electrically coupled between the first terminal T₁ and the resonant tank capacitor Cᵣ. The zero-crossing detection circuit 300 detects the resonant tank current Iᵣ and the resonant tank voltage Vᵣ. In addition, the zero-crossing detection circuit 300 acquires information about the resonant period T according to the resonant tank current Iᵣ and the resonant tank voltage Vᵣ. In an embodiment, the zero-crossing detection circuit 300 includes a first current transformer CT₁, a first resistor R₁, a comparator COM, a second resistor R₂, a first capacitor C₁ and a Zener diode DZ. The input terminal of the first current transformer CT₁ is electrically coupled with the resonant tank 21. For example, the first current transformer CT₁ is electrically coupled between the first terminal T₁ and the resonant tank capacitor Cᵣ to acquire the resonant tank current Iᵣ. The first terminal and the second terminal of the first resistor R₁ are electrically coupled with the output terminal of the first current transformer CT₁. Moreover, the second terminal of the first resistor R₁ is also electrically coupled with the ground terminal G. The positive input terminal of the comparator COM and the first terminal of the first resistor R₁ are electrically coupled with the output terminal of the first current transformer CT₁. The negative input terminal of the comparator COM and the second terminal of the first resistor R₁ are electrically coupled with the ground terminal G. The second resistor R₂ is electrically coupled between a voltage source Vi and the output terminal of the comparator COM. The anode of the Zener diode D_{z} is electrically coupled with the ground terminal G. The cathode of the Zener diode D_{z} is electrically coupled with the output terminal of the comparator COM. The first capacitor C₁ is electrically coupled between the output terminal of the comparator COM and the ground terminal G. Moreover, the first capacitor C₁ and the Zener diode D_{z} are electrically coupled with each other in parallel.

Due to the hardware structure of the zero-crossing detection circuit 300, a pulse width modulation (PWM) signal is outputted from the output terminal of the comparator COM. Whenever the resonant tank current Iᵣ is zero (i.e., at the time point corresponding to the zero-crossing point), the PWM signal is switched from the high level state to the low level state or switched from the low level state to the high level state at the time point corresponding to the zero-crossing point of the resonant tank current Iᵣ. After the upper switch Qₕ of the inverter circuit 20 switched from the conducting state to the non-conducting state and the resonant tank voltage Vᵣ is zero, the time interval of the PWM signal outputted by the comparator COM form the first level switching (corresponding to the first zero-crossing time point) to the second level switching (corresponding to the second zero-crossing time point) is substantially equal to a half of the resonant period T. In other words, the resonant period T is equal to twice the time interval between the first zero-crossing time point and the second zero-crossing time point. The resonant period T is defined by the resonant tank current Iᵣ and the resonant tank voltage Vᵣ, and the zero-crossing detection circuit 300 acquires information about the resonant period T according to the resonant tank current Iᵣ and the resonant tank voltage Vᵣ.

The negative peak value detection circuit 301 is electrically coupled with the resonant tank 21. For example, the negative peak value detection circuit 301 is electrically coupled between the first terminal T₁ and the resonant tank capacitor Cᵣ. The negative peak value detection circuit 301 detects the resonant tank current Iᵣ and the resonant tank voltage Vᵣ. Moreover, the negative peak value detection circuit 301 acquires the information about the negative peak value current I_{N} of the resonant tank current Iᵣ according to the resonant tank current Iᵣ. In an embodiment, the negative peak value detection circuit 301 includes a second current transformer CT₂, a third resistor R₃, a fourth resistor R₄, a negative feedback amplifier Cₐₘₚ, a diode D and a second capacitor C₂. The input terminal of the second current transformer CT₂ is electrically coupled with the resonant tank 21. For example, the second current transformer CT₂ is electrically coupled between the first terminal T₁ and the resonant tank capacitor Cᵣ to acquire the resonant tank current Iᵣ. The first terminal and the second terminal of the third resistor R₃ are electrically coupled with the output terminal of the second current transformer CT₂. The second terminal of the third resistor R₃ is electrically coupled with the ground terminal G. The non-inverting terminal of the negative feedback amplifier Camp is electrically coupled with the first terminal of the third resistor R₃ and the output terminal of the second current transformer CT₂. The inverting terminal of the negative feedback amplifier Camp is electrically coupled with the output terminal of the negative feedback amplifier Cₐₘₚ. The cathode of the diode D is electrically coupled with the output terminal of the negative feedback amplifier Cₐₘₚ. The fourth resistor R₄ is electrically coupled between the anode of the diode D and the ground terminal G. The second capacitor C₂ is electrically coupled between the anode of the diode D2 and the ground terminal G. In addition, with the second capacitor C₂ and the fourth resistor R₄ are electrically coupled with each other in parallel. Due to the above circuitry structure of the negative peak value detection circuit 301, the negative peak value detection circuit 301 acquires the information about negative peak current value I_{N} of the resonant tank current Iᵣ according to the resonant tank current Iᵣ and the resonant tank voltage Vᵣ.

In case that the parameter acquisition unit 30 is implemented with a software component, an algorithm, a calculation formula and/or a parameter relationship table can be previously stored in the parameter acquisition unit 30. In the cooperation of the algorithm, the calculation formula and/or the parameter relationship table, the negative peak value detection circuit 301 acquires the information about negative peak current value I_{N} of the resonant tank current Iᵣ according to the resonant tank current Iᵣ and the resonant tank voltage Vᵣ.

Preferably but not exclusively, the microprocessor 31 is a digital signal processor (DSP) or a microcontroller unit (MCU). The microprocessor 31 is electrically coupled with the parameter acquisition unit 30. In an embodiment, the microprocessor 31 includes a first calculation unit 310 and a second calculation unit 311.

A first expression is previously stored in the first calculation unit 310. The first calculation unit 310 acquires the parameter information about the resonant period T from the parameter acquisition unit 30. The first calculation unit 310 calculates the inductance of the resonant tank equivalent inductor L_{eq} according to the capacitance of the resonant tank capacitor Cᵣ, the first expression and the received resonant period T. In addition, the first calculation unit 310 provides a first calculation result about the inductance of the resonant tank equivalent inductor L_{eq}.

A second expression is previously stored in the second calculation unit 311. The second calculation unit 311 acquires the first calculation result about the inductance of the resonant tank equivalent inductor Le from the first calculation unit 310. The second calculation unit 311 acquires information about the reference current value I₀, the time difference Δt and the negative peak current value I_{N} of the resonant tank current Iᵣ according to the resonant tank current Iᵣ and the resonant tank voltage Vᵣ. The second calculation unit 311 calculates the impedance value of the resonant tank equivalent impedance R_{eq} according to the inductance of the resonant tank equivalent inductor L_{eq}, the reference current value Jo, the time difference Δt, the negative peak value I_{N} of the resonant tank current Iᵣ and the second expression. In addition, the second calculation unit 311 provides a second calculation result about the impedance value of the resonant tank equivalent impedance R_{eq}.

In an embodiment, the control unit 4 acquires the resonant tank equivalent inductor L_{eq} and the resonant tank equivalent impedance R_{eq} according to the first calculation result and the second calculation results from the microprocessor 31. Furthermore, the control unit 4 performs various control operations on the resonant circuit 22 according to the resonant tank equivalent inductor L_{eq} and the resonant tank equivalent impedance R_{eq}. For example, the control unit 4 can determine whether the heating coil 210 is enabled or disabled and determine whether the foodstuff container is placed on the heating device 1 according to the resonant tank equivalent inductor L_{eq} and the resonant tank equivalent impedance R_{eq}. Moreover, the control unit 4 determines the burden ratio of the heating coil 210 according to the inductance of the resonant tank equivalent inductor L_{eq} and the impedance value of the resonant tank equivalent impedance R_{eq}. Moreover, the output power from the heating device 1 is corrected by the control unit 4 in real time according to the change of the inductance of the resonant tank equivalent inductor L_{eq} and the change of the impedance value of the resonant tank equivalent impedance R_{eq}. Moreover, the control unit 4 can recognize the material of the foodstuff container according to the inductance of the resonant tank equivalent inductor L_{eq} and the impedance value of the resonant tank equivalent impedance R_{eq}.

Hereinafter, the first expression (1) and the second expression (2) will be roughly derived with reference to FIGS. 1A, 1B, 2 and 3.

The main working principle of the present invention is based on the natural response characteristics of the resonant tank 21. After the time point t=t0, the natural response of the resonant tank 21 occurs. Consequently, the general formula of the resonant tank current Iᵣ can be expressed as the following mathematic formula (3):

iᵣ(t)=e^{-αt}(B₁ cos ω_{d}+t+B₂ sin ω_{d}t) (3);

In the above mathematic formula, iᵣ(t) is the resonant tank current Iᵣ as a function of time, α is an attenuation coefficient, ω_{d} is a damping resonance frequency, and B₁ and B₂ are arbitrary constants determined by the boundary conditions. Since the heating device 1 is an induction cooking stove, ωₒ²>>α². Under this circumstance, the resonant tank 21 is operated in an underdamped zone. The damping resonance frequency can be simplified as: ω_{d}=\sqrt{ωₒ²−α²}≅ωₒ, where cₒ is a natural resonance frequency. Through the angle sum and difference identities, the mathematic formula (3) can be rearranged as the mathematic formula (4):

iᵣ(t)=Iₚe^{-αt} sin(ωₒ^{t}+θ) (4);

In the above mathematic formula, Iₚ is the current peak value when the resonant tank 21 is in the natural resonance state, and θ is the angle.

In the mathematic formula (4), some parameters may be expressed as the following general formulae:

$${ω}_{0} = \frac{1}{\sqrt{{L}_{eq} {C}_{r}}} ; \qquad ( 5 )$$

$$α = \frac{{R}_{eq}}{2 {L}_{eq}} ; \qquad ( 6 )$$

Consequently, the mathematic formula (1) may be derived from the mathematic formula (5). In addition, the relationship between the resonance frequency fₒ and the resonant period T may be expressed as the following mathematic formula:

$${f}_{o} = \frac{1}{T} = \frac{{ω}_{o}}{2 π} ; \qquad ( 7 )$$

Generally, in case that the duty cycle of the upper switch Qₕ is smaller, the discharge waveform of the resonant tank 21 in the negative half cycle is relatively complete. Under this circumstance, the zero-crossing detection circuit 300 can be used to obtain the half resonant period T/2. After the half resonant period T/2 is introduced into the mathematic formula (1) according to the mathematic formula (7), the first calculation unit 310 acquires the inductance of the resonant tank equivalent inductor L_{eq}.

Moreover, the magnitude of the resonant tank current Iᵣ is zero at sin 0° and sin π. Consequently, the zero-crossing point of the resonant tank current Iᵣ is taken as the reference point, the calculation is carried out in the form of the relative angle. Please refer to FIG. 2 again. For example, when the upper switch Qₕ is switched from the conducting state to the non-conducting state and the resonant tank voltage Vᵣ is zero (e.g., at the time point t0), the instantaneous current value of the resonant tank current Iᵣ is served as the reference current value I₀. That is, at the time point t0, the upper switch Qₕ is turned off, and the lower switch Qₗ is turned on. The first zero-crossing time point is the time point corresponding to the first zero value of the resonant tank current Iᵣ after the upper switch Qₕ is switched from the conducting state to the non-conducting state (e.g., at the time point t1). The time point t1 corresponds to the angle π. The negative peak current value I_{N} is the maximum value of the resonant tank current Iᵣ (i.e., at the time point t2). The time point t2 corresponds to the angle 3π/2. According to the mathematic formula (4), the relationship between the current peak value Iₚ, the reference current value I₀, the negative peak current value I_{N} and the angle θ may be expressed as the mathematic formulae (8) and (9):

I₀=Iₚ sin θ (8);

I_{N}=Iₚe^{-αt}^{₁} sin(ωₒt₁+θ)=−Iₚe^{-αt}^{₁} (9);

As shown in FIG. 2, after the upper switch Qₕ is switched from the conducting state to the non-conducting state, the sampling time point of the reference current value I₀ is obtained at the time point when the time difference Δt is subtracted from the first zero-crossing time point of the resonant tank current Iᵣ. Moreover, the negative peak current value I_{N} of the resonant tank current Iᵣ occurs at the time point t2 (i.e., the time point corresponding to the angle 3π/2). Consequently, the following mathematic formulae (10), (11) and (12) can be obtained.

$$sin θ = sin ( π - \frac{Δ t}{T} 2 π ) = sin ( \frac{Δ t}{T} 2 π ) ; \qquad ( 10 )$$

$$sin ( {ω}_{0} {t}_{1} + θ ) = sin \frac{3 π}{2} = - 1 ; \qquad ( 11 )$$

$${t}_{1} = Δ t + \frac{T}{4} ; \qquad ( 12 )$$

The mathematic formula (2) can be derived from the mathematic formulae (8), (9), (10), (11) and (12).

In an embodiment, the detection unit 3 is implemented with a controller.

In the above embodiment, the inverter circuit 20 includes the upper switch Qₕ and the lower switch Qₗ. It is noted that numerous modifications and alterations may be made while retaining the teachings of the invention. In some other embodiments, the inverter circuit 20 includes a single switch or at least four switches. In case that the inverter circuit 20 includes a single switch, the first terminal T₁ and the second terminal T₂ of the resonant tank 21 are electrically connected with the first conducting terminal and the second conducting terminal of the switch. In case that the inverter circuit 20 includes four switches and the inverter circuit 20 is formed as a full-bridge inverter circuit, the first terminal T₁ and the second terminal T₂ of the resonant tank 21 are electrically coupled with the first conducting terminal and the second conducting terminal of the lower switch of one of the two bridge arms of the inverter circuit 20. In case that the inverter circuit 20 includes a single switch or at least four switches, the operations of the heating device are similar to the those of the heating device 1, and not redundantly described herein.

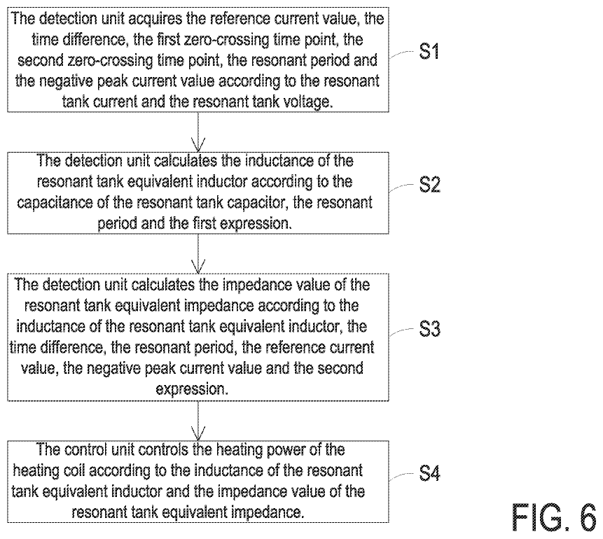

Please refer to FIG. 6. FIG. 6 is a flowchart illustrating a detecting method for a heating device according to an embodiment of the present invention. The detecting method is applied to the detection unit 13 of the heating device 1 as shown in FIG. 1B. The detecting method includes the following steps.

In a step S1, the detection unit 3 acquires the reference current value I₀, the time difference Δt, the first zero-crossing time point, the second zero-crossing time point, the resonant period T and the negative peak current value I_{N} according to the resonant tank current Iᵣ and the resonant tank voltage Vᵣ.

In a step S2, the detection unit 3 calculates the inductance of the resonant tank equivalent inductor L_{eq} according to the capacitance of the resonant tank capacitor Cᵣ, the resonant period T and the first expression.

In a step S3, the detection unit 3 calculates the impedance value of the resonant tank equivalent impedance L_{eq} according to the inductance of the resonant tank equivalent inductor L_{eq}, the time difference Δt, the resonant period T, the reference current value I₀, the negative peak current value I_{N} and the second expression.

In a step S4, the control unit 4 controls the heating power of the heating coil 210 according to the inductance of the resonant tank equivalent inductor L_{eq} and the impedance value of the resonant tank equivalent impedance R_{eq}.

Furthermore, in the step S4, the control unit 4 performs various control operations on the resonant circuit 22. For example, the control unit 4 determines whether the foodstuff container is placed on the heating device 1 according to inductance of the resonant tank equivalent inductor L_{eq} and the impedance value the resonant tank equivalent impedance R_{eq}. Moreover, the control unit 4 determines the burden ratio of the heating coil 210 according to the inductance of the resonant tank equivalent inductor L_{N} and the impedance value of the resonant tank equivalent impedance R_{eq}. Moreover, the control unit 4 recognizes the material of the foodstuff container on the heating device 1 according to the inductance of the resonant tank equivalent inductor L_{eq} and the impedance value of the resonant tank equivalent impedance R_{eq}.

From the above descriptions, the present invention provides the heating device and the detecting method for the heating device. The heating device includes the resonant tank. The heating device includes the resonant tank. The main working principle of the present invention is based on the natural response characteristics of the resonant tank in the negative half cycle. The inductance of the resonant tank equivalent inductor and the impedance value of the resonant tank equivalent impedance are calculated according to the current information of the resonant tank, the first expression and the second expression. When compared with the conventional heating device, the heating device of the present invention needs to equip less detection circuits. Consequently, the heating device is simplified and the cost is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A heating device, comprising:
a resonant circuit comprising:
an inverter circuit configured to provide a resonant tank current and a resonant tank voltage; and
a resonant tank comprising a heating coil, a resonant tank capacitor, a resonant tank equivalent inductor and a resonant tank equivalent impedance;
a detection unit electrically coupled with the resonant circuit, wherein the detection unit detects the resonant tank current and the resonant tank voltage to acquire a reference current value, a first zero-crossing time point, a second zero-crossing time point, a time difference, a resonant period and a negative peak current value, wherein the reference current value is a current value of the resonant tank current when the resonant tank voltage is zero, the time difference is a time length between a time point when the resonant tank voltage is zero and the first zero-crossing time point, and the resonant period is defined according to the first zero-crossing time point and the second zero-crossing time point; and
a control unit configured to control the inverter circuit to output the resonant tank current and the resonant tank voltage, so that a heating power of the heating coil is adjustable,
wherein the detection unit calculates an inductance of the resonant tank equivalent inductor according to a capacitance of the resonant tank capacitor, the resonant period and a first expression, the detection unit calculates an impedance value of the resonant tank equivalent impedance according to the inductance of the resonant tank equivalent inductor, the time difference, the resonant period, the reference current value, the negative peak current value and a second expression, and the control unit controls the heating power of the heating coil according to the inductance of the resonant tank equivalent inductor and the impedance value of the resonant tank equivalent impedance,
wherein L_{eq} is the inductance of the resonant tank equivalent inductor, Cᵣ is the capacitance of the resonant tank capacitor, and T is the resonant period, and the first expression is expressed as a following mathematic formula:
$${L}_{eq} = {( \frac{1}{2 π T \sqrt{{C}_{r}}} )}^{2} ,$$
wherein R_{eq} is the impedance value of the resonant tank equivalent impedance, I₀ is the reference current value, Δt is the time difference, and I_{N} is the negative peak value of the resonant tank current, and the second expression is expressed as a following mathematic formula:
$${R}_{eq} = \frac{2 {L}_{eq}}{Δ t + \frac{T}{4}} ln ( \frac{- {I}_{0}}{{I}_{N}} \frac{1}{sin ( \frac{Δ t}{T} 2 π )} ) .$$

2. The heating device according to claim 1, wherein the detection unit comprises a parameter acquisition unit, and the parameter acquisition unit is electrically coupled with the resonant tank to detect the resonant tank current and the resonant tank voltage, wherein when the resonant tank voltage is zero, the parameter acquisition unit acquires the resonant period and the negative peak current value of the resonant tank current according to the resonant tank current and the resonant tank voltage.

3. The heating device according to claim 2, wherein the parameter acquisition unit comprises:
a zero-crossing detection circuit electrically coupled with the resonant tank, wherein the zero-crossing detection circuit detects the resonant tank current and the resonant tank voltage, and the zero-crossing detection circuit acquires the resonant period according to the resonant tank current and the resonant voltage; and
a negative peak value detection circuit electrically coupled with the resonant tank, wherein the negative peak value detection circuit detects the resonant tank current and the resonant voltage, and the negative peak value detection circuit acquires the negative peak current value according to the resonant tank current and the resonant tank voltage.

4. The heating device according to claim 3, wherein the zero-crossing detection circuit comprises:
a first current transformer, wherein an input terminal of the first current is electrically coupled with the resonant tank to receive the resonant tank current;
a first resistor, wherein a first terminal and a second terminal of the first resistor are electrically coupled with an output terminal of the first current transformer, and the second terminal of the first resistor is electrically coupled with a ground terminal;
a comparator, wherein a positive input terminal of the comparator is electrically coupled with the first terminal of the first resistor and the output terminal of the first current transformer, and a negative input terminal of the comparator is electrically coupled with the second terminal of the first resistor and the ground terminal;
a second resistor electrically coupled between a voltage source and an output terminal of the comparator;
a Zener diode, wherein an anode of the Zener diode is electrically coupled with the ground terminal, and a cathode of the Zener diode is electrically coupled with the output terminal of the comparator, and
a first capacitor electrically coupled between the output terminal of the comparator and the ground terminal, wherein the first capacitor and the Zener diode are electrically coupled with each other in parallel.

5. The heating device according to claim 3, wherein the negative peak value detection circuit comprises:
a second current transformer, wherein an input terminal of the second current transformer is electrically coupled with the resonant tank to receive the resonant tank current;
a third resistor, wherein a first terminal and a second terminal of the third resistor are electrically coupled with an output terminal of the second current transformer, and the second terminal of the third resistor is electrically coupled with a ground terminal;
a negative feedback amplifier, wherein a non-inverting terminal of the negative feedback amplifier is electrically coupled with a first terminal of the third resistor and the output terminal of the second current transformer, and an inverting terminal of the negative feedback amplifier is electrically coupled with an output terminal of the negative feedback amplifier;
a diode, wherein a cathode of the diode is electrically coupled with the output terminal of the negative feedback amplifier;
a fourth resistor electrically coupled between an anode of the diode and the ground terminal; and
a second capacitor electrically coupled between the anode of the diode and the ground terminal, wherein the second capacitor and the fourth resistor are electrically coupled with each other in parallel.

6. The heating device according to claim 4, wherein the detection unit further comprises a microprocessor, and the microprocessor comprises:
a first calculation unit, wherein the first expression is previously stored in the first calculation unit, and the first calculation unit calculates the inductance of the resonant tank equivalent inductor according to the capacitance of the resonant tank capacitor, the resonant period provided by the zero-crossing detection circuit and the first expression, and the first calculation unit provides a first calculation result to the control unit; and
a second calculation unit, wherein the second expression is previously stored in the second calculation unit, wherein the second calculation unit acquires the first calculation result from the first calculation unit, the second calculation unit acquires the reference current value, the time difference and the negative peak current value of the resonant tank current according to the resonant tank current and the resonant tank voltage, the second calculation unit calculates the impedance value of the resonant tank equivalent impedance according to the inductance of the resonant tank equivalent inductor, the time difference, the resonant period, the reference current value, the negative peak value of the resonant tank current and the second expression, and the second calculation unit provides a second calculation result to the control unit.

7. The heating device according to claim 6, wherein the microprocessor is a digital signal processor or a microcontroller unit.

8. The heating device according to claim 1, wherein the heating device is an induction cooking stove.

9. The heating device according to claim 1, wherein the inverter circuit comprises an upper switch and a lower switch, which are connected with each other, wherein the upper switch and the lower switch are alternately turned on and turned off, and a first terminal and a second terminal of the resonant tank are electrically coupled with two conducting terminals of the lower switch, respectively.

10. A detecting method for a detection unit of a heating device, the heating device further comprising a resonant circuit, the resonant circuit comprising an inverter circuit and a resonant tank, the inverter circuit providing a resonant tank current and a resonant tank voltage, the resonant tank comprising a heating coil, a resonant tank capacitor, a resonant tank equivalent inductor and a resonant tank equivalent impedance, the detecting method comprising steps of:
(a) detecting the resonant tank current and the resonant tank voltage to acquire a reference current value, a first zero-crossing time point, a second zero-crossing time point, a time difference, a resonant period and a negative peak current value, wherein the reference current value is a current value of the resonant tank current when the resonant tank voltage is zero, the time difference is a time length between a time point when the resonant tank voltage is zero and the first zero-crossing time point, and the resonant period is defined according to the first zero-crossing time point and the second zero-crossing time point;
(b) calculating an inductance of the resonant tank equivalent inductor according to a capacitance of the resonant tank capacitor, the resonant period and a first expression, wherein the first expression is expressed as a following mathematic formula:
$${L}_{eq} = {( \frac{1}{2 π T \sqrt{{C}_{r}}} )}^{2} ,$$
where L_{eq} is the inductance of the resonant tank equivalent inductor, Cᵣ is the capacitance of the resonant tank capacitor, and T is the resonant period;
(c) calculating an impedance value of the resonant tank equivalent impedance according to the inductance of the resonant tank equivalent inductor, the time difference, the resonant period, the reference current value, the negative peak current value and a second expression, wherein the second expression is expressed as a following mathematic formula:
$${R}_{eq} = \frac{2 {L}_{eq}}{Δ t + \frac{T}{4}} ln ( \frac{- {I}_{0}}{{I}_{N}} \frac{1}{sin ( \frac{Δ t}{T} 2 π )} ) ,$$
where R_{eq} is the impedance value of the resonant tank equivalent impedance, I₀ is the reference current value, Δt is the time difference, and I_{N} is the negative peak value of the resonant tank current; and
(d) controlling a heating power of the heating coil according to the inductance of the resonant tank equivalent inductor and the impedance value of the resonant tank equivalent impedance.

11. The detecting method according to claim 10, wherein the heating device is an induction cooking stove, and the step (b) further comprises a step of determining whether a foodstuff container is placed on the heating device according to the inductance of the resonant tank equivalent inductor and the impedance value of the resonant tank equivalent impedance.

12. The detecting method according to claim 10, wherein the heating device is an induction cooking stove, and the step (b) further comprises a step of determining a burden ratio of the heating coil according to the inductance of the resonant tank equivalent inductor and the impedance value of the resonant tank equivalent impedance.

13. The detecting method according to claim 10, wherein the heating device is an induction cooking stove, and the step (b) further comprises a step of recognizing a material of a foodstuff container on the heating device according to the inductance of the resonant tank equivalent inductor and the impedance value of the resonant tank equivalent impedance.
